(19) United States
(12) Patent Application Publication
(10) Pub. No.: US 2009/0127293 A1
(43) Pub. Date: May 21, 2009

(54) TRIGGER-ACTUATED DISPENSER HEADS

(76) Inventor: Vincent DE LAFORCADE, Rambouillet (FR)

Correspondence Address: O'BRIEN JONES, PLLC, 8200 Greensboro Drive, Suite 1020A, McLean, VA, 22102, US

(21) Appl. No.: 12/271,877

(22) Filed: Nov. 15, 2008

Related U.S. Application Data
(60) Provisional application No. 61/012,692, filed on Dec. 10, 2007.

(30) Foreign Application Priority Data
Nov. 15, 2007 (FR) 07 59079

(51) Int. Cl. B65D 83/00; B23P 19/00

(52) U.S. Cl. 222/402.11; 29/700; 222/402.15

(57) ABSTRACT

A dispenser trigger head for a container provided with a dispenser rod, the head comprising a base configured to be fastened on the container; a lever hinged to the base, the lever defining a actuation surface located to the side of the dispenser head; and an endpiece carried by and molded integrally with the lever, the endpiece being configured to couple to the dispenser rod and being in communication with at least one composition ejection orifice for ejecting composition in a forward direction.

This application claims the benefits of priority of French Application No. 07 59079, filed on Nov. 15, 2007. This application also claims the benefits of priority of U.S. Provisional Application No. 61/012,692, filed on Dec. 10, 2007, which is incorporated by reference herein in its entirety.

The present teachings relate to a dispenser head for a container having a dispenser rod, e.g. a valve rod or a pump rod.

### BACKGROUND

Various safety mechanisms have been proposed to prevent accidental operation of the dispenser rod, e.g. while the container is being transported.

Document FR 2 692 559 thus discloses a dispenser head comprising a pushbutton having an endpiece that is coupled with the dispenser rod, the pushbutton being movable relative to a cap that is fastened on the container, which cap has a member for blocking the dispenser rod being hinged thereto to move between an active position that prevents the dispenser rod from being depressed and an inactive position that allows the dispenser rod to be depressed. The dispenser rod is made with a groove, and the blocking member is in the form of a disk that is pierced by an opening in which the dispenser rod is engaged. One end of the opening is sufficiently narrow to enable the disk to engage in the groove and thus prevent the dispenser rod from being depressed. Such a mechanism is relatively complex, requiring a dispenser rod that is provided with a groove and requiring a plurality of separately-fabricated parts to be assembled together.

U.S. Pat. No. 5,282,551 discloses a blocking member that is made integrally with a base that is fastened on the container, the blocking member being connected thereto via bridges of material that are elastically deformable. The blocking member can be moved in translation and needs to be actuated simultaneously with the pushbutton, which is not very convenient for the user.

Other safety mechanisms are disclosed in U.S. Pat. No. 3,940,023, FR 2 228 686, and FR 2 864 823.

EP 1 661 822 A1, U.S. Pat. No. 6,286,723 B1, U.S. Pat. No. 6,003,739, US 2003/0192910 A1, U.S. Pat. No. 4,441,633, US 2006/0113327 A1 and WO 01/36275 disclose dispenser heads in which the control surface against which the user must press in order to trigger dispensing is situated not on the top of the dispenser head but on a lever located beside the dispenser head. Such dispenser heads are also referred to as “trigger” heads, and for the most part they are of structure that is relatively complex, and therefore expensive.

EP 1 661 822 A1 simplifies the fabrication of such a head to some extent by molding it as a single part. Nevertheless putting it into place on the container is relatively complex and first use requires bridges of material to be broken, thereby requiring greater thrust to be applied to the control lever.

### SUMMARY

There exists a need to further improve dispenser heads, in particular to simplify fabrication thereof and to reduce the cost thereof.

In one aspect, various exemplary embodiments of the present teachings provide a dispenser head for a container provided with a dispenser rod, the dispenser head comprising:
a base configured to be fastened on the container;
a lever hinged to the base, for example via a film hinge; and
an endpiece carried by the lever, being molded integrally with the lever, the endpiece being configured to couple to the dispenser rod and being in communication with at least one product ejection orifice.

In an aspect, various exemplary embodiments of the present teachings provide a dispenser head for a container provided with a dispenser rod that is controlled by being compressed and/or tilted, the head comprising:
a base that is configured to be fastened on the container;
a lever that is hinged to the base;
an endpiece that is configured to couple with the dispenser rod and that communicates with at least one product ejection orifice; and
at least one bridge of material connecting the endpiece to the lever that is present at least before the endpiece is coupled to said rod and at least before a first actuation of the lever.

The product, also referred to herein as composition, can be distributed other than according to the longitudinal axis of the dispenser rod or other than according to the longitudinal axis of the container.

The at least one bridge of material may be distinct from the hinge between the lever and the base.

Thus, according to an exemplary embodiment of the present teachings, in a mold-exit configuration, the base is situated on one side of a hinge, e.g. a hinge made in the form of a film hinge, and the lever together with the endpiece are situated on the opposite side of the hinge.

With the exception of an optional fitted spray nozzle, such a dispenser head can be relatively easily made as a one-piece molding, thereby reducing the cost thereof.

The dispenser rod of the container may be controlled by being depressed and/or by being tilted. When the dispenser rod is controlled by being depressed, it is moved parallel to its longitudinal axis which may coincide with the longitudinal axis of the container.

The endpiece may be connected to the lever via at least one flexible bridge of material. The flexible bridge(s) of material may deform when the lever is actuated in order to act on the dispenser head. The flexible bridge(s) of material may deform for example in twisting, e.g. about an axis parallel to the hinge axis of the lever. The flexible bridge(s) of material may be non-breakable.

When said at least one bridge of material is breakable, the top wall of the lever may include a cap-forming portion or flange that extends at least in part in register with the ejection portion of the endpiece and that is suitable for coming to bear against said ejection portion when the lever is actuated in order to cause the dispenser rod to move.

In an exemplary embodiment, the lever defines an actuator surface against which the user can press in order to cause dispensing to take place; this actuation surface may be situated close to the end of the lever at the opposite of the geometric axis whereby it is hinged to the base. Thus, the dispenser head may be actuated in the manner of a “trigger” dispenser head. To start the distribution, the user exerts a force on the lever which tends to pivot the lever, this force having a non-null component oriented perpendicularly to the longitudinal axis of the container. The control surface approaches the axis of the dispenser rod during the movement caused by the user to activate the dispenser rod.

In an exemplary embodiment, the lever has two uprights between which the endpiece extends at least in part, the above-mentioned flexible bridges of material each being connected to a respective upright.

In an exemplary embodiment, the lever has at least a first portion in relief and the base has at least a second portion in relief, with which the first portion in relief can engage by snap-fastening in order to hold the lever in a configuration in which it is folded down onto the base. By way of example the first portion in relief is carried by a duct including the endpiece and serving to convey the product to the ejection orifice(s).

The dispenser head may include a fitted spray nozzle, in particular a nozzle fastened to one end of the above-mentioned duct.

The base, the lever, and the endpiece may be molded as a single piece of thermoplastic material.

The dispenser head may be inscribed within the envelope of the container when the container is observed looking along its axis. This serves to avoid the dispenser head impeding movement of containers along a conveyor of a manufacturing line. For example, the envelope of the container may be cylinder-shaped and the entire dispenser head including the lever and the portion for ejecting the product may be inscribed within this cylinder when the container is observed along the axis of said cylinder.

The lever may include an opening situated facing the dispenser duct that includes the endpiece, or it may have the duct passing therethrough. Where appropriate, the presence of the opening can enable the duct to move a certain amount relative to the lever during actuation thereof.

In an exemplary embodiment, the dispenser head includes a blocking member configured to take up an active position in which it opposes depression of the dispenser rod and an inactive position in which it allows the dispenser rod to be depressed when the lever is actuated, the blocking member being movable relative to the base and being carried thereby.

The blocking member may conserve the position in which it is left by the user.

The blocking member may be connected via a hinge to the base, for example, being molded integrally therewith. By way of example, the blocking member may be connected to a radially-inner surface of the base, in particular when the base is annular in shape.

The blocking member may include an opening or a laterally-open notch through which the dispenser rod of the container passes, said notch having an edge that is shaped to snap-fasten on the dispenser rod when the blocking member passes from the inactive position to the active position. Thus, the dispenser rod may cooperate with the blocking member firstly so as to enable the user to feel it passing from the active position to the inactive position, and vice versa, and secondly to hold the blocking member in the configuration in which it is left by the user. The opening or notch may include first and second edge portions substantially matching the shape of the dispenser rod, said first and second portions being constituted for example by circular arcs having the same radius but with centers that are offset. These portions may define between them a ridge that serves for snap-fastening purposes. The opening may have a close outline having for example the general form of the numeral eight. The opening may have two opposed ridges forming the boundary of both circular portions of the eight, the two opposed ridges being overcome via an elastic deformation by the dispenser rod when moving from the active position to the inactive position or vice versa. Each circular portion may have a diameter substantially equal to the diameter of the dispenser rod.

By way of example, the blocking member may present first and second regions that are situated at different heights, e.g. regions of different thicknesses, the second region possibly being thicker than the first, the second region underlying an end edge face of the endpiece when the blocking member is in the blocking position to prevent the endpiece being depressed through a stroke that is sufficient to give rise to dispensing, with only the first region underlying the end edge face of the endpiece when the blocking member is in the inactive position, so that depression of the endpiece is no longer opposed by the second region. Thus, the endpiece can be prevented from being depressed by the blocking member in spite of using a conventional type of dispenser rod that does not include a groove for engaging the blocking member of the kind disclosed in above-mentioned FR 2 692 559.

The blocking member may include two outer uprights defining thrust surfaces against which the user can press to cause it to go from the active position to the inactive position, and vice versa. These uprights may be curved at their bases, e.g. being concave towards each other and towards the dispenser rod, other shapes nevertheless being possible. The blocking member and/or the base may include markings, e.g. “ON” and/or “OFF”, printed and/or molded in relief, or carried by a fitted label, in order to inform the user about the active or inactive nature of the blocking member, depending on its position relative to the base.

The lever may extend at least in part over the above-mentioned uprights.

The angular stroke of the blocking member may be limited, at least in one direction, by the blocking member coming into abutment against the base. In the opposite direction, the angular stroke of the blocking member may be limited by the dispenser rod coming into abutment in the bottom of a notch in the blocking member.

The base may be configured to snap-fasten on the container or to be fastened thereon in some other way, e.g. by screw fastening or by adhesive. The base may also be integrally molded with at least a portion of the container, where appropriate.

In another aspect, various exemplary embodiments of the present teachings provide a device comprising a container and a dispenser head as defined above fastened on the container.

The container may be an aerosol can, for example.

The container may contain a cosmetic, including a care product, or a non-cosmetic composition, e.g. a household cleaner.

Various exemplary embodiments of the present teachings also provide a method of making a dispenser head, the method comprising:
integrally molding the base, the lever, and the endpiece with the lever not being in its utilization position; and
folding the lever onto the base so as to bring it into its utilization position, movement of the lever being accompanied by movement of the endpiece that is integral therewith.

The head may be molded with the blocking member in its active configuration. This may prevent the dispenser rod being actuated while the head is being mounted on the container.

### BRIEF DESCRIPTION OF THE DRAWINGS

The present teachings can be better understood on reading the following detailed description of non-limiting exemplary embodiments thereof, and on examining the accompanying drawings, in which:

FIG. 1 is a diagrammatic perspective view showing an exemplary embodiment of a device made in accordance with the present teachings;

FIG. 2 shows the dispenser head of FIG. 1 in isolation;

FIG. 3 shows the dispenser head of FIG. 1 in isolation in a molding configuration;

FIG. 4 shows the dispenser head of FIG. 1 in isolation seen from beneath, the blocking member being in an inactive configuration;

FIG. 5 is an axial half-section of the dispenser head of FIG. 1 shown in isolation, the blocking member being in an active position;

FIG. 6 is a view analogous to FIG. 5, the blocking member in an active position;

FIG. 7 is an axial half-section in a section plane perpendicular to the plane of FIGS. 5 and 6;

FIG. 8 is a view analogous to FIG. 1 showing a variant exemplary embodiment of a device in accordance with the present teachings;

FIG. 9 shows the dispenser head of FIG. 8 in isolation in a molding configuration;

FIGS. 10 and 11 show the dispenser head of FIG. 8 in isolation in views from beneath, the blocking member being shown respectively in the active configuration and in the inactive configuration;

FIGS. 12 and 13 are fragmentary side views showing the dispenser head of FIG. 8 respectively while not dispensing and while dispensing;

FIG. 14 is a fragmentary plan view showing a variant exemplary embodiment of the blocking member;

FIG. 15 is a view in elevation of another exemplary embodiment of a dispenser head in a molding configuration;

FIGS. 16 and 17 are respectively a side view and a front view of the dispenser head of the FIG. 15; and

FIGS. 18 and 19 are sections of the dispenser head of FIG. 15 according to respective section lines XVIII and IXX.

### MORE DETAILED DESCRIPTION

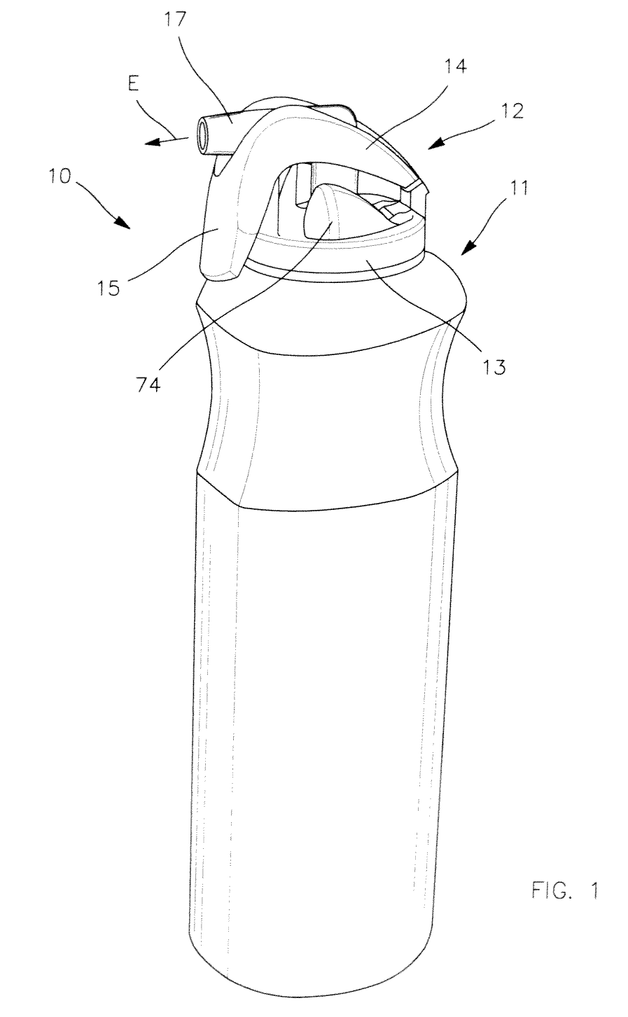

The packaging and dispenser device 10 shown in FIG. 1 comprises a container 11, e.g. an aerosol can, and a dispenser head 12 fastened on the container 11, specifically fitted to the top thereof in the example described.

The container 11 includes a valve comprising a hollow dispenser rod 33 that can be seen in FIG. 4, that is operated by being pressed down, and through which the composition is dispensed. The valve includes a return member for returning the dispenser rod.

The valve may be of any conventional type for an aerosol can.

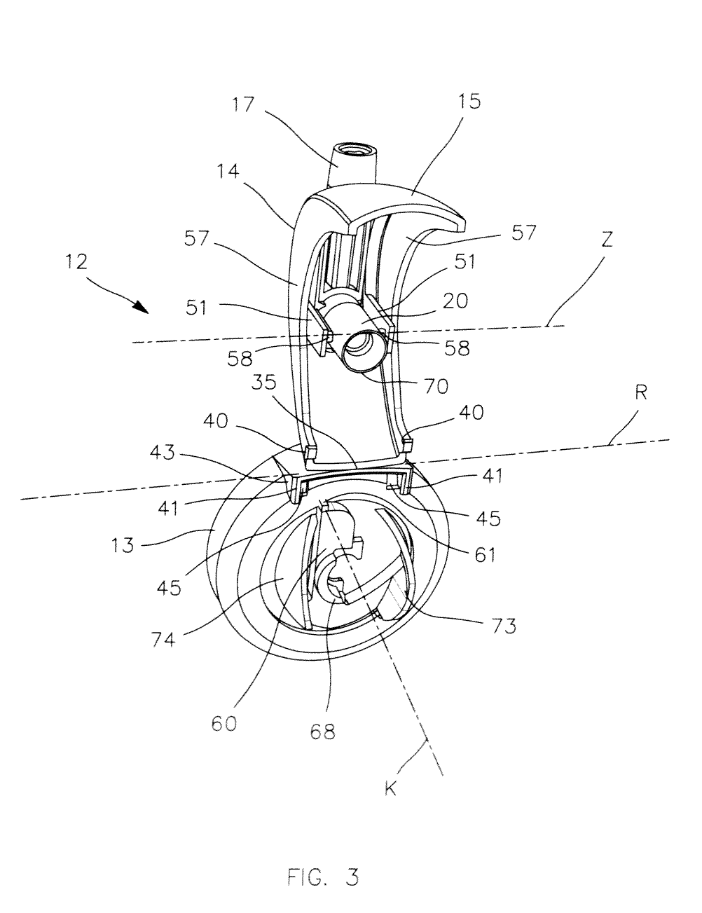

The dispenser head 12 includes a base 13, also referred to as a “band”, that is used for fastening it on the container 11, and a control lever 14 that is hinged to the base 13 to pivot about a pivot axis R (shown in FIG. 3), the lever 14 defining an actuation surface also referred to as control surface 15 on which the user can press to cause the composition contained in the container 11 to be dispensed. The control surface 15 is situated at the front of the lever 14, on the side of the dispenser head 12, the head being of the “trigger” type. The control surface 15 is oriented forward.

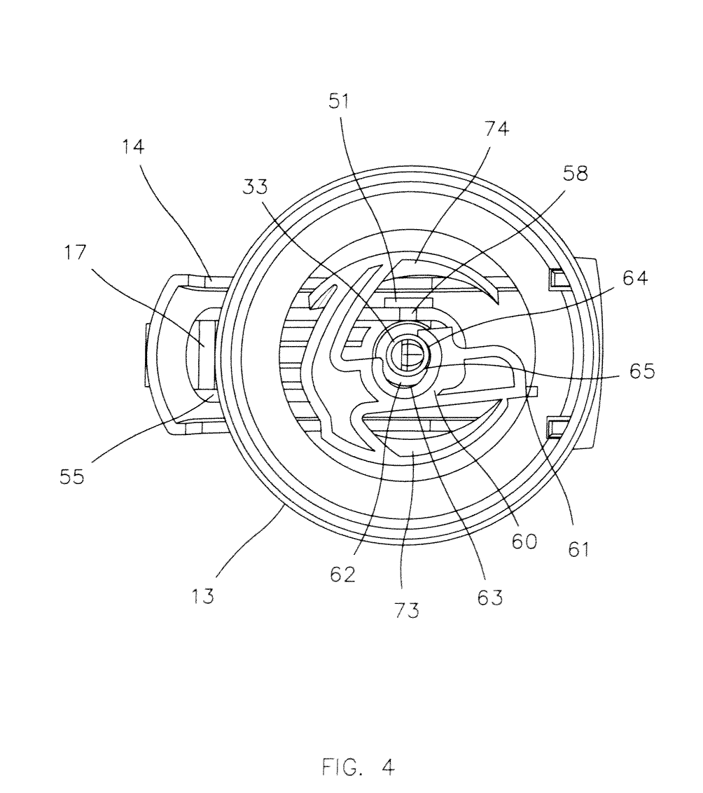

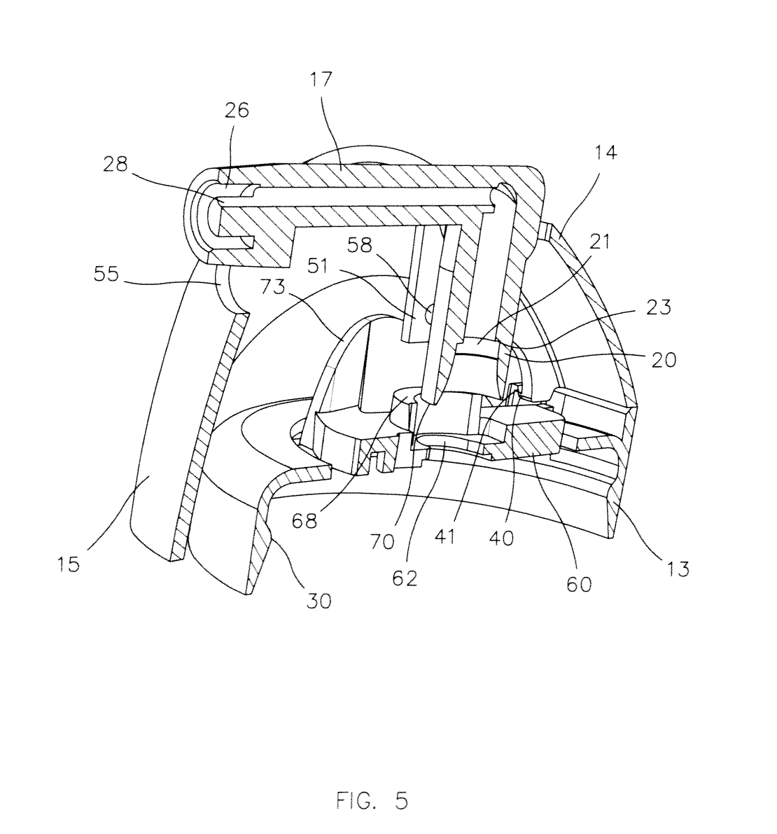

The dispenser head 12 has a duct 17 enabling the product for spraying to be ejected forwardly in a direction E. The direction E is generally perpendicular to the longitudinal axis of the container 11. In the example shown, the duct 17 includes a portion that forms a connection endpiece 20 that is coupled to the dispenser rod 33, extending substantially parallel thereto, and an ejection portion that extends substantially perpendicularly to the axis of the endpiece 20, as shown in FIG. 3. The duct 17 may have an ejection portion which extends perpendicularly relative to the endpiece. The endpiece 20 defines a downwardly-flared housing 21 for receiving the rod 33, this housing 21 being defined at the top by a shoulder 23 against which the rod 33 comes into abutment, as can be seen in FIG. 5.

The duct 17 includes an annular housing 26 at its front end for receiving a dispenser nozzle (of conventional type and not shown), e.g. a nozzle having swirl channels, or of some other type. In the example shown, the nozzle is fed by a channel 28 in the duct 17.

The base 13 can be fastened on the container 11 in various ways, and in the example shown the base 13 has an annular bead 30 configured to snap into a corresponding groove in the container, e.g. a groove formed by a cup of the container carrying the valve.

The lever 14 is hinged to the base 13 about the axis R via a film hinge 35, being integrally molded with the base 13 while in an open configuration, as shown in FIG. 3.

By way of example, the pivot axis R is perpendicular to the longitudinal axis of the container 11.

The lever 14 has first portions in relief 40, such as teeth, that are configured to snap-fasten against second portions in relief 41 formed together with the base 13, so as to act by snap-fastening to retain the lever 14 once it is folded down onto the base 13.

The base has an upright 43 of generally U-shaped cross-section with a web carrying the film hinge 35 and with side flanges having catch rims at their top ends, which rims constitute the second portions in relief 41 and project towards each other. Openings 45 are made in the base 13 to enable these catch rims to be molded.

The endpiece 20 is carried by two uprights 51 that are connected at their top ends to a top wall 52 of the lever 14. The lever also carries two side flanges 57 that extend the top wall 52 downwards. The endpiece 20 and the uprights 51 extend at least in part within the recess formed between the two flanges 57 and the top wall 52.

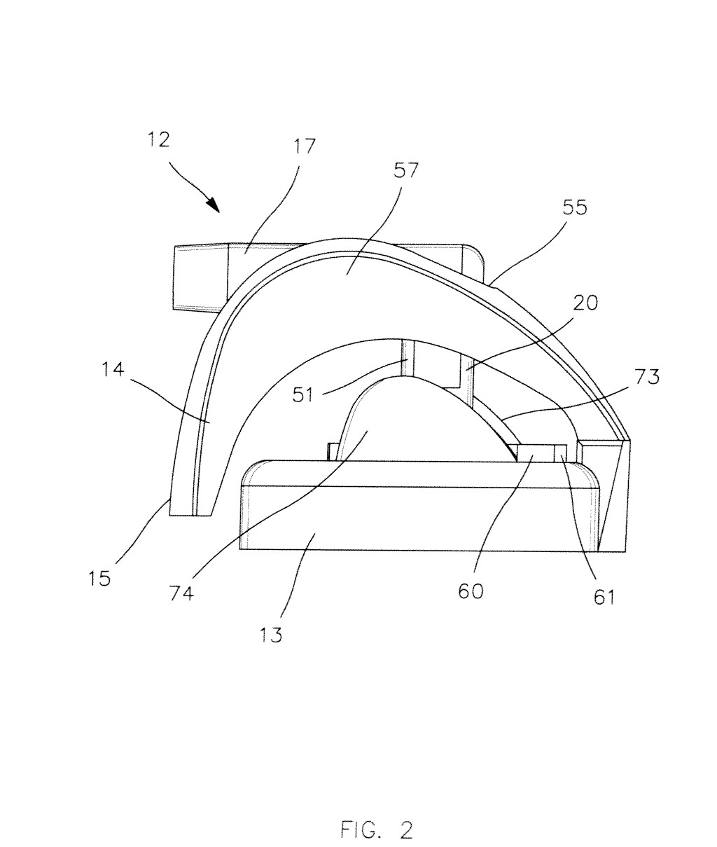

The top wall 52 is pierced by an opening 55 within which the duct 17 extends. The opening 55 also extends towards the front of the lever 14 so as to enable the duct 17 to project forwards relative to the control surface 15, as can be seen in FIG. 2.

The ejection duct 17 and the control surface 15 of the lever 14 may be disposed as shown substantially one above the other and to the side of the base 13. The lower end of the lever may be located as shown above a plane perpendicular to the axis of the dispenser rod and comprising the lower end of the base.

The lever 14 in side view, for example as shown in FIG. 2, may have the form of an arch which goes above the level of the hinge 35 and down under the level of the hinge 35, such that the control surface 15 is at a level under the level of the ejection orifice, in a use position where the container has the dispenser rod oriented vertically and upward. The control surface is for example oriented forward in the use position.

The user holding the container in his hand may activate the trigger by pressing with the forefinger toward the container. The force applied by the user and the ejection direction of the product are for example substantially opposed. The force applied on the control surface has for example a non-null component in a plane perpendicular to the longitudinal axis of the container 11, i.e. a non-null horizontal component when the container is held upright.

The endpiece 20 is connected to the uprights 51 by flexible bridges of material 58, these bridges of material 58 in the example shown being of circular cross-section with an axis Z, shown in FIG. 3, that is parallel to the pivot axis R.

When the user presses on the control surface 15, the lever 14 can pivot downwards relative to the base 13, thereby likewise tending to entrain the endpiece 20 downwards by means of the uprights 51 and the bridges of material 58. The bridges can deform in twisting about the axis Z so as to enable the endpiece 20 to remain substantially parallel to the axis of the dispenser rod 33 while it is being depressed. The torsion of the bridges enables the endpiece 20 to pivot relative to the lever 14.

When the user releases the lever 14, the return force to which the dispenser rod 33 is subjected returns the endpiece 20 and the lever 14 in an upward direction.

In order to avoid accidental actuation of the dispenser rod 12, it advantageously includes a safety mechanism, as described below, serving to selectively block actuation of the dispenser rod 33.

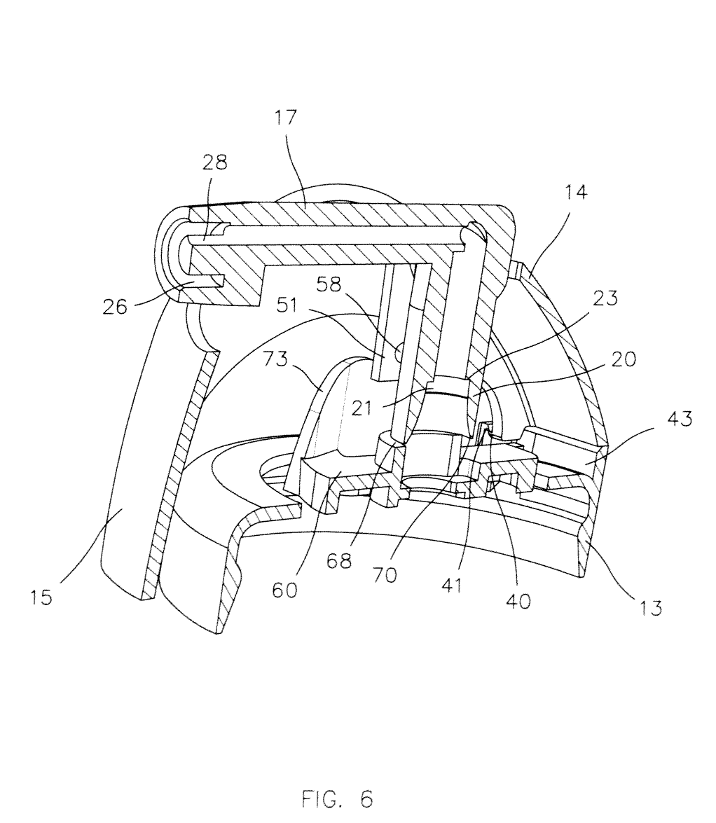

In the exemplary embodiment shown in FIGS. 1 to 7, this safety mechanism comprises a blocking member 60 that is connected to the base 13 via a hinge 61 of axis K that is integrally molded with the base 13 and with the blocking member 60. The axis K is substantially parallel to the direction in which the dispenser rod 33 is depressed.

The blocking member 60 can pivot between a first position in which it allows the dispenser rod 33 to be actuated, which position is referred to as its “inactive” (or “unlocked”) position, and a second position in which it blocks such actuation, which position is referred to as its “active” (or “locking”) position.

The blocking member 60 includes a notch 62 that is laterally open, as can be seen in particular in FIG. 4, the notch having an edge that includes a first portion 63 and a second portion 64, both of which are circular and of radius matching the radius of the dispenser rod 33, the centers thereof being offset, these portions 63 and 64 defining a ridge 65 where they join, which ridge is snapped past the control rod 33 when the blocking member 60 goes from the active position to the inactive position, or vice versa.

The blocking member 60 is of varying thickness, having a rib 68 that can bear against the bottom end edge face 70 of the endpiece 20 when the blocking member 60 is in the active position, as shown in FIG. 6, so as to prevent the endpiece 20 moving downwards and actuating the rod 33.

When the blocking member 60 is in the inactive position, the rib 68 is no longer facing the bottom end edge face 70 of the endpiece 20, so the endpiece is free to move downwards along a stroke that is sufficient to actuate the control rod 33 so as to cause composition to be dispensed.

The blocking member 60 has two opposite outer uprights 73 and 74 that can be pressed by the user to move the blocking member 60 between its active and inactive positions.

In the exemplary embodiment shown, these uprights present a curved shape at their bases, being concave towards each other.

In order to bring the blocking member 60 into the active position, the user presses against the upright 73, thereby forcing the dispenser rod 33 to go past the ridge 65 and be received in the back of the notch 62. In this configuration, the endpiece 20 is prevented from being depressed by the rib 68.

In order to able to dispense the product, the user presses in the opposite direction against the upright 74, thereby bringing the control rod 33 into register with the portion 64 of the edge of the notch 32 and moving the rib 68 away from the bottom end edge face 70 of the endpiece 20, thereby allowing it to be depressed sufficiently to actuate the dispenser rod 33.

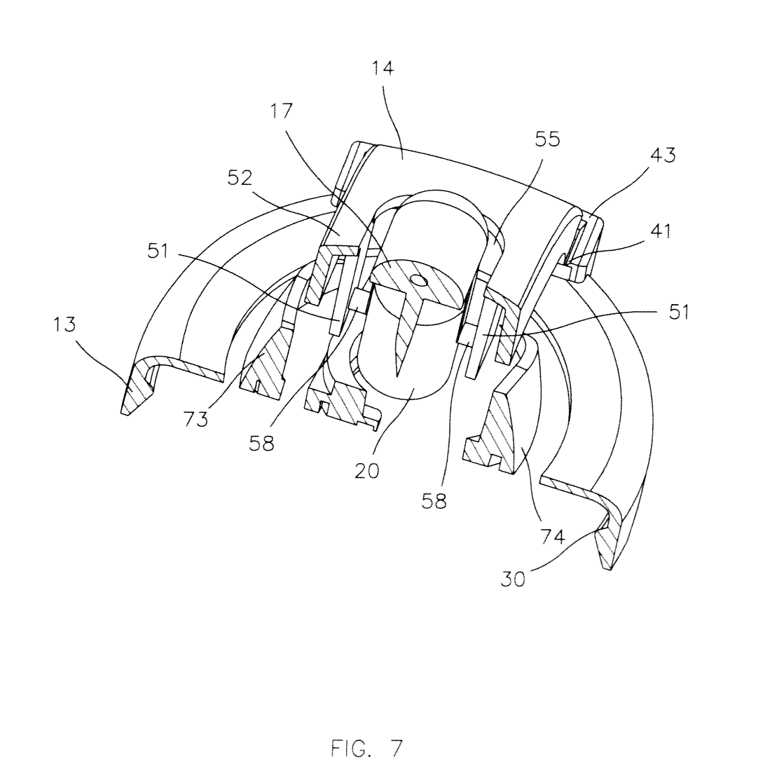

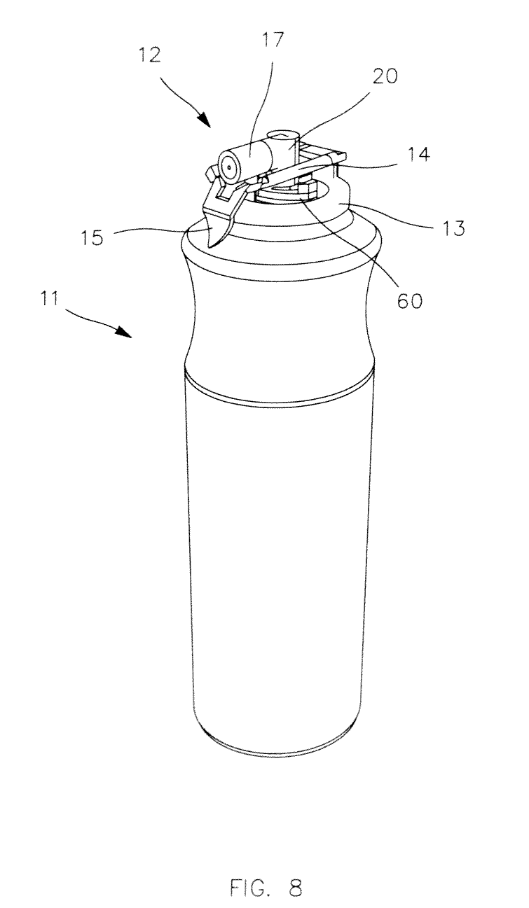

In the exemplary embodiment shown in FIGS. 8 to 13, the dispenser head 12 is made somewhat differently. The same reference symbols are retained to designate elements that are identical or that have the same function as in the above-described embodiment.

In this embodiment, the blocking member 60 is generally anchor-shaped, as best seen in FIGS. 9-11, and the user can actuate the ends 81 and 82 thereof so as to move it between its active and inactive positions.

By way of example, in this embodiment the lever 14 is held in the folded-down position by a retaining tab 93 that is carried by the duct 17 and that snap-fastens on a portion in relief 95 of the base, situated remote from the hinge 35. The lever 14 is made with an opening 96 that enables the retaining tab 93 to be molded.

Also in this embodiment, the endpiece 20 is connected directly by means of flexible bridges 58 to the lever 14 between the branches thereof that define the side of the opening 55.

In FIG. 10, it can be seen that the blocking member 60 is in the active position, the bottom edge face 70 of the endpiece 20 partially overlying the rib 68 of the blocking member.

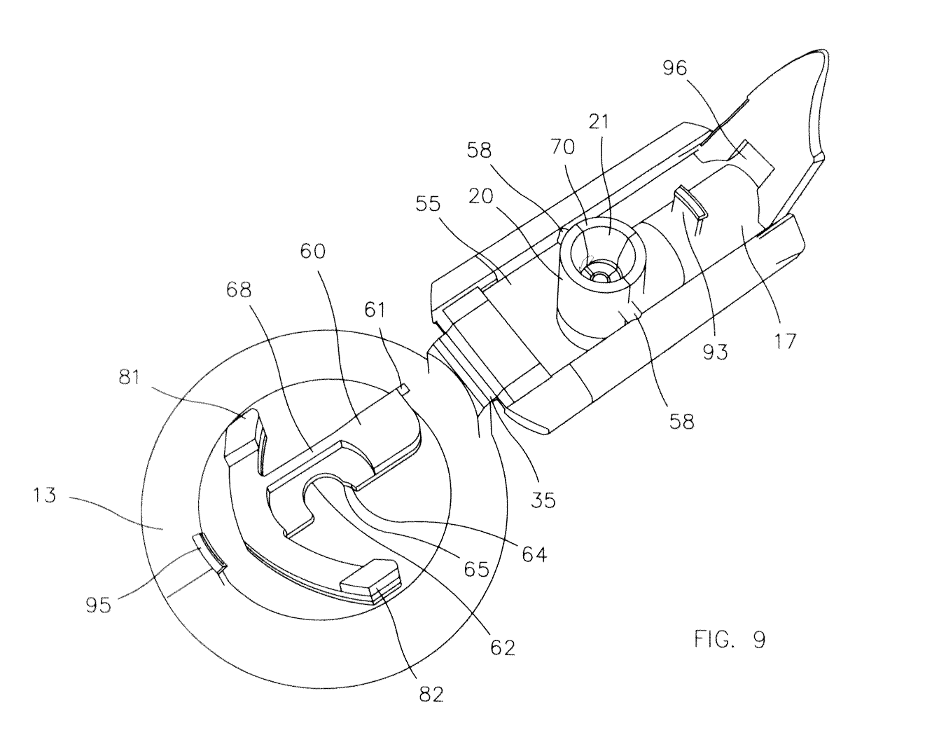

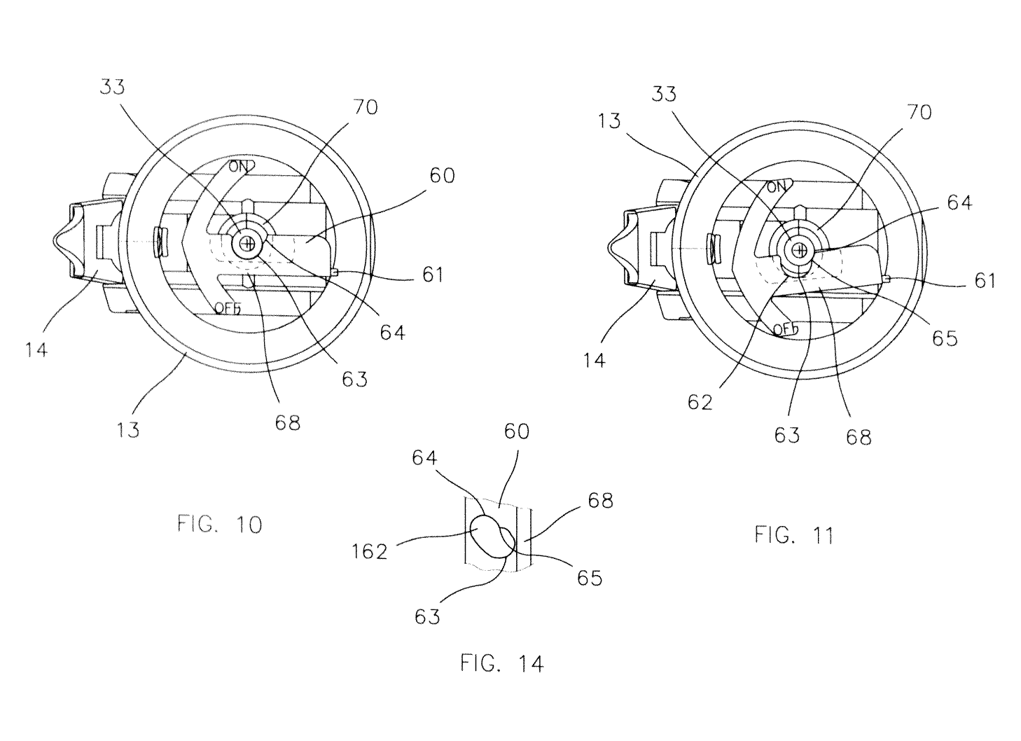

In FIG. 11, it can be seen that the blocking member 60 has moved into the inactive position, the bottom edge face 70 of the endpiece 20 no longer overlying the rib 68 and the endpiece 20 being capable of being depressed further.

In this inactive configuration, the dispenser rod 33 is situated substantially in register with the portion 64 of the edge of the notch 62.

In FIG. 10, the dispenser rod 33 is situated substantially against the portion 63 of the edge of the notch 62.

In FIGS. 12 and 13 it can be seen that when the user presses on the control surface 15, the lever 14 can tilt downwards while the bridges of material 58 enable the endpiece 20 to remain substantially on the same axis as the dispenser rod.

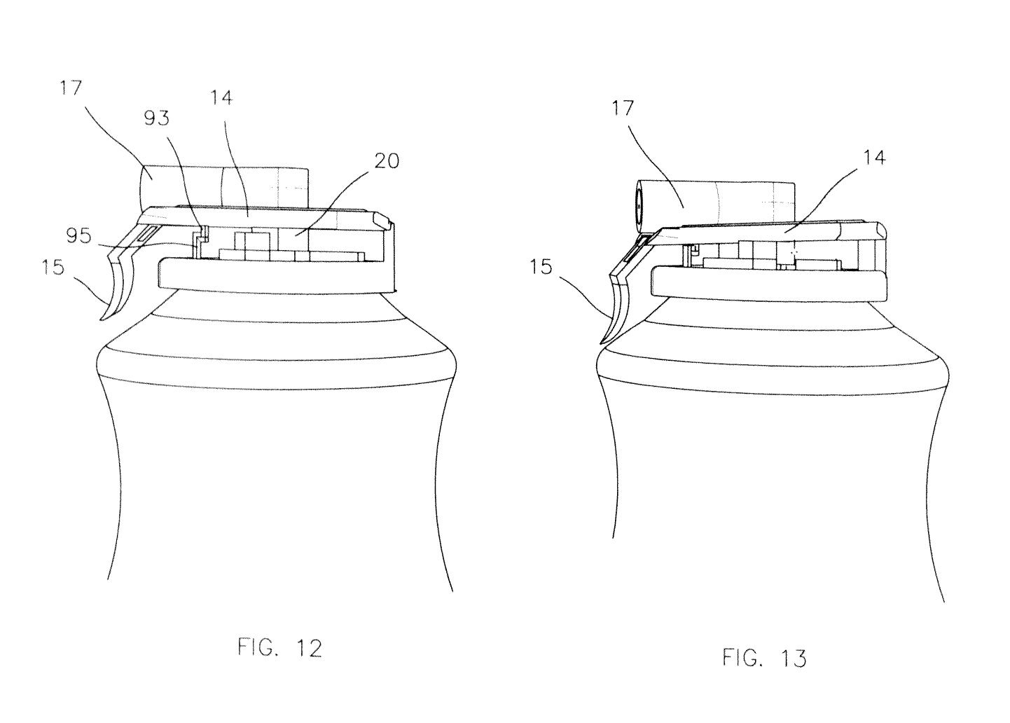

In the exemplary embodiment of FIG. 14, the member 60 includes an opening 162 that replaces the notch 62 and that presents a closed outline.

The dispenser rod 33 is engaged in the opening 162 and can cooperate with the edge portions 63 and 64.

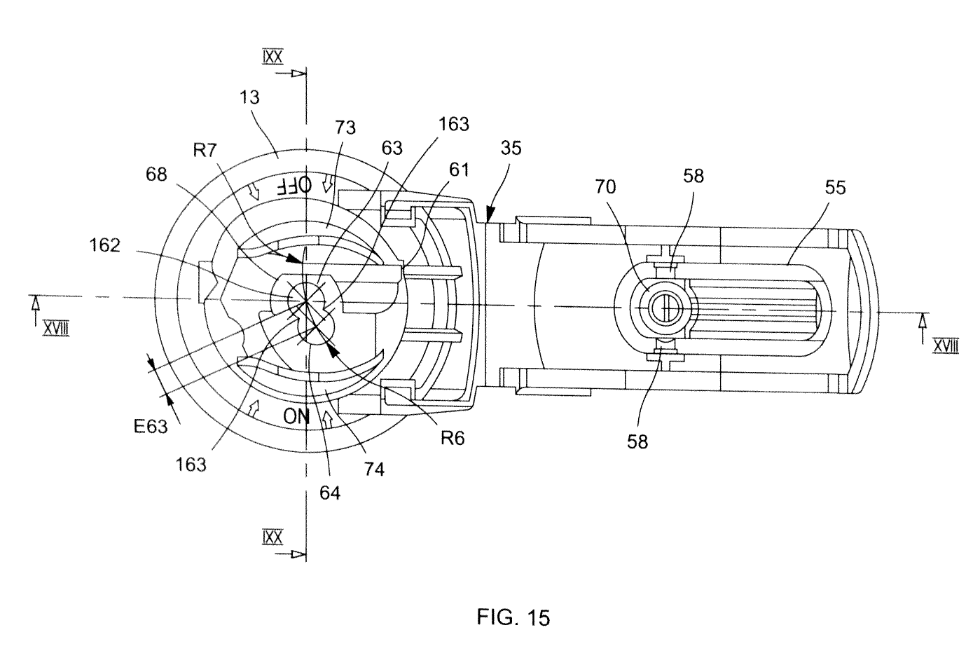

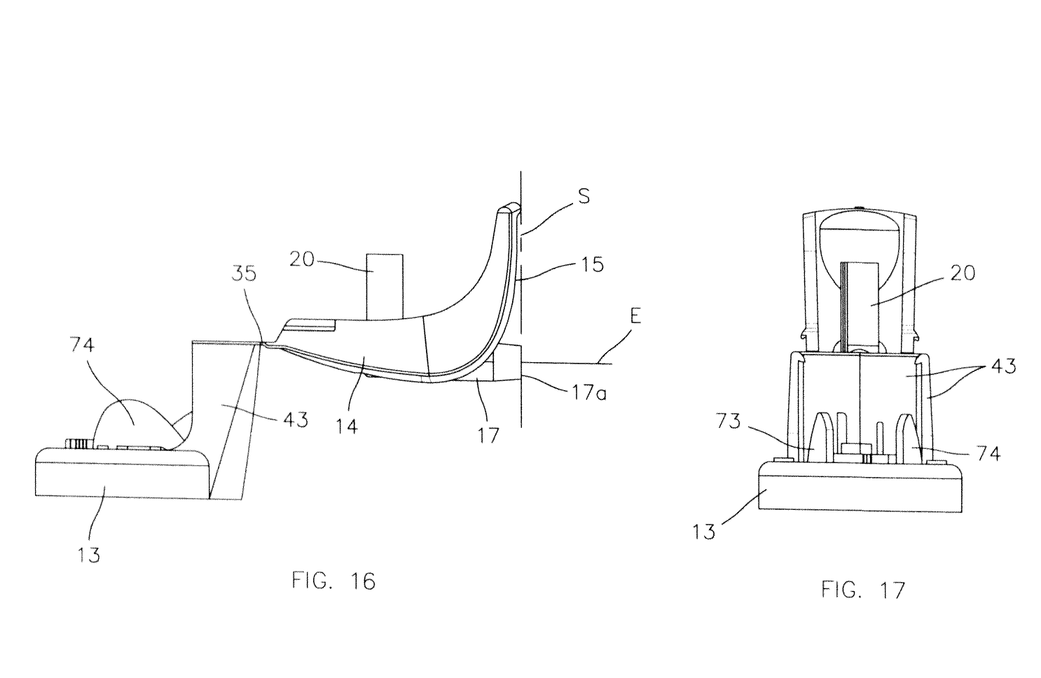

In the exemplary embodiment shown in FIGS. 15-19, the blocking member 60 comprises an opening 162 whose outline is closed and is substantially in the form of an eight, in a transverse section taken perpendicularly to the longitudinal axis of the dispenser rod 33. The opening 162 comprises two outline portions that are substantially circular around respective axes spaced from each other by a distance E63 in FIG. 15. The closer the ridges 163 located at the junction of both circular portions of the outline, the more difficult is the crossing by the dispenser rod of the space formed between these two ridges. The radius R6 of each of the two circular portions corresponds for example substantially to the outer radius of the dispenser rod 33. The centers of the circular portions are situated on a circular path at the same distance of the axis K of the hinge 61 of the blocking member 60 relative to the base 13.

Visual markings comprising, for example, the inscriptions “ON” and/or “OFF” and/or arrows are for example inscribed next to uprights 73 and 74 as illustrated.

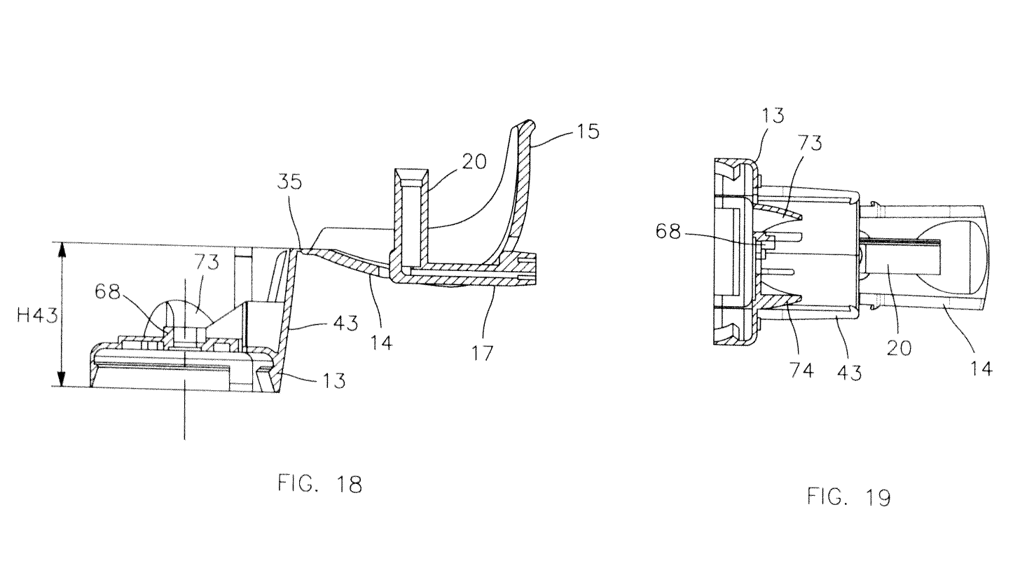

As shown in FIG. 18, the upright 43 of the base 13, on which the hinge is connected, may have a height H43 greater than the height of the corresponding upright of the embodiment of FIG. 2.

The height H43 is measured between the lower end of the base 13 and the upper end of the upright 43. For example, the hinge 35 may be situated at a height greater than the height of uprights 73 and 74 and greater than the height of the lower end of the endpiece 20 when the lever is at rest and ready to be activated by the user to distribute product. The height H43 is for example greater than or equal to about 20 mm, for example ranging from about 20 mm to about 30 mm or from about 24 mm to about 28 mm, or, for example, about 27 mm.

It can be seen in FIG. 16 that the free end 17a of the duct 17 may be situated in a plane S perpendicular to the direction E and forward relative to the control surface 15.

Naturally, the present teachings are not limited to the exemplary embodiments described herein.

In particular, the dispenser head can be provided with a resilient return member suitable for returning the lever 14 into its initial position after each actuation, and this can be useful when the valve of the container does not present sufficient force.

In a variant, the lever may press via its bottom face against the dispenser duct.

The dispenser head in accordance with various exemplary embodiments of the present teachings may be fitted with a container provided with a pump instead of being fitted to an aerosol can.

The term “comprising a” should be understood as being synonymous with “comprising at least one” unless specified to the contrary.

Although the present teachings herein have been described with reference to various exemplary embodiments, it is to be understood that those embodiments are merely illustrative of the principles and applications of the present teachings. It is therefore to be understood that numerous modifications may be made to the illustrative embodiments and that other arrangements may be devised without departing from the spirit and scope of the present teachings and claims.

What is claimed is:

1. A trigger-actuated dispenser head for a container provided with a dispenser rod, the head comprising:
a base configured to be fastened on the container;
a lever hinged to the base, the lever defining an actuation surface located to a side of the dispenser head; and
an endpiece carried by and molded integrally with the lever, the endpiece being configured to couple to the dispenser rod and being in communication with at least one composition ejection orifice for ejecting composition in a forward direction.

2. A head according to claim 1, wherein the dispenser rod of the container is controlled by being depressed.

3. A head according to claim 1, wherein the endpiece is connected to the lever via at least one flexible bridge of material.

4. A head according to claim 3, wherein the at least one flexible bridge of material deforms when the lever is actuated to act on the dispenser rod.

5. A head according to claim 1, wherein the lever is connected via a film hinge to the base.

6. A head according to claim 4, wherein the at least one flexible bridge of material comprises two flexible bridges of material.

7. A head according to claim 1, wherein the actuation surface is configured to be pressed on by a user to actuate the lever.

8. A head according to claim 7, wherein the actuation surface is situated close to an end of the lever opposite to its pivot axis for pivoting relative to the base.

9. A head according to claim 1, wherein the lever comprises two uprights between which the endpiece extends.

10. A head according to claim 4, wherein the lever comprises two uprights between which the endpiece extends, and wherein the flexible bridge of material is connected to a respective upright.

11. A head according to claim 1, wherein the lever comprises at least a first portion in relief and the base comprises at least a second portion in relief with which the first portion in relief can snap-fasten in order to hold the lever in a configuration in which it is folded down onto the base.

12. A head according to claim 11, wherein the lever is connected via a film hinge to the base and the second portion in relief is carried by an upright of the base, the film hinge being connected to said upright.

13. A head according to claim 1, further comprising a spray nozzle fitted to the head.

14. A head according to claim 1, wherein the base, the lever, and the endpiece are molded as a single piece.

15. A head according to claim 1, wherein the head is inscribed within the envelope of the container when the container is observed looking along its axis.

16. A head according to claim 1, further comprising a blocking member configured to take up an active position in which it opposes the dispenser rod being depressed, and an inactive position in which it allows the dispenser rod to be depressed, the blocking member being movable relative to the base and being carried thereby.

17. A head according to claim 16, wherein the blocking member is connected by means of a hinge to the base and being molded integrally therewith.

18. A head according to claim 16, wherein the blocking member comprises a notch that is laterally open, for passing the dispenser rod, the notch having an edge configured to snap against the dispenser rod when the blocking member passes from the inactive position to the active position.

19. A head according to claim 18, wherein the notch comprises first and second edge portions matching substantially to the shape of the dispenser rod.

20. A head according to claim 16, wherein the blocking member comprises first and second regions of different heights, the second region underlying an end edge face of the endpiece when the blocking member is in the active position to oppose depression of the endpiece, with only the first region underlying the end edge face of the endpiece when the blocking member is in the inactive position.

21. A head according to claim 16, wherein the blocking member comprises two uprights defining surfaces against which a user can press in order to cause the blocking member to pass from the active position to the inactive position, and vice versa.

22. A head according to claim 21, wherein the uprights are curved at their bases, being concave towards each other and towards the dispenser rod.

23. A head according to claim 21, wherein the lever extends at least in part over the uprights.

24. A head according to claim 1, wherein the base is configured to snap-fasten on the container.

25. A head according to claim 1, wherein the lever defines an opening situated facing a dispenser duct for distributing product, including the endpiece, or having the duct passing therethrough.

26. A head according to claim 1, wherein the at least one bridge of material is non-breakable.

27. A head according to claim 1, wherein the lever comprises two arms disposed one each side of the endpiece which extends at right angle from a duct defining the ejection orifice, the duct protruding forward in relation to a surface joining the two arms.

28. A device comprising a container and a trigger-actuated dispenser head fastened on the container, the container comprising a dispenser rod, the dispenser head comprising:
a base configured to be fastened on the container;
a lever hinged to the base, the lever defining an actuation surface located to the side of the dispenser head; and
an endpiece carried by and molded integrally with the lever, the endpiece being configured to couple to the dispenser rod and being in communication with at least one duct for ejecting the product in a forward direction.

29. A device according to claim 28, wherein the container is an aerosol can.

30. A device according to claim 28, wherein the container contains a cosmetic.

31. A device according to claim 28, wherein the container comprises a dispenser rod controlled by being depressed.

32. A method of making a dispenser head, the method comprising:
molding as a single piece a base, a lever, and an endpiece with the lever not being in its utilization configuration, the lever carrying the endpiece; the lever being hinged to the base and comprising an actuation surface situated at the opposite of a hinge, and
folding the lever down onto the base so as to bring it into its utilization configuration, the movement of the lever being accompanied by movement of the endpiece that is integral therewith.

33. A method according to claim 32, further comprising molding the head with a blocking member in the active configuration.
